(19) United States
(12) Patent Application Publication
(10) Pub. No.: US 2022/0266826 A1
(43) Pub. Date: Aug. 25, 2022

(54) VEHICLE CONTROL DEVICE AND VEHICLE

(71) Applicant: HONDA MOTOR CO., LTD., Tokyo (JP)

(72) Inventors: Kentaro KASUYA, Tokyo (JP); Hiroyuki TOKUNAGA, Tokyo (JP)

(21) Appl. No.: 17/674,190

(22) Filed: Feb. 17, 2022

(30) Foreign Application Priority Data
Feb. 25, 2021 (JP) 2021-029003

(51) Int. Cl. B60W 30/12; B60W 40/114; B60W 10/20; G06V 20/56

(52) U.S. Cl. CPC B60W 30/12; B60W 40/114; B60W 10/20; G06V 20/588; B60W 2420/42; B60W 2510/202; B60W 2520/14; B60W 2552/53

(57) ABSTRACT

The present invention includes: a camera that is mounted in a vehicle and that captures a forward-view image of the vehicle; a learner that learns a traveling line of the host vehicle in a lane from the image captured by the camera; and a vehicle controller that performs control of returning the vehicle to the learned traveling line when a yaw rate due to disturbance is generated. Moreover, in the lane, a range that has a predetermined width from a center of a traveling width is set as a learning range and a range other than the learning range is set as a no-learning range. The learner does not learn the traveling line in the no-learning range.

### CROSS-REFERENCE TO RELATED APPLICATION

This application is based upon and claims priority from the Japanese Patent Application No. 2021-029003, filed on Feb. 25, 2021, the entire contents of which are incorporated herein by reference.

### BACKGROUND OF THE INVENTION

### 1. Field of the Invention

The present invention relates to a technique for a vehicle and a vehicle control device that performs driving assist.

### 2. Description of the Related Art

There is a system that performs driving assist such as lane keep assist by applying torque to a steering system such that a vehicle can keep traveling in a lane based on vehicle-mounted camera information.

For example, JP4295138B discloses a technique of calculating a yaw rate of a vehicle by calculating a current yaw angle of a vehicle with respect to a reference line extending along a traveling road and removing an interest point change component attributable to the current yaw angle. JP4295138B discloses that such a process is performed to cancel a yaw rate generated by a steering operation by a driver and extract only a relative yaw rate component generated by disturbance such as crosswind, unevenness of a road surface, and the like.

### SUMMARY OF THE INVENTION

JP4295138B states that, after the disturbance generates the relative yaw rate, control of cancelling out this yaw rate is performed. However, in the technique disclosed in JP4295138B, a yaw angle generated by a yaw rate before the cancelling-out causes the vehicle to travel in a direction different from a traveling line before the occurrence of disturbance.

Moreover, in the technique described in JP4295138B, the vehicle travels along a traveling line different from a traveling line before occurrence of disturbance also after a yaw rate generated by the disturbance or the like is canceled out.

The present invention has been made in view of such background and an object of the present invention is to achieve stable traveling in a drive assist technique.

To solve the problem described above, the present invention includes: a camera that is mounted in a vehicle and that captures a forward-view image of the vehicle; a learner that learns a traveling line of the host vehicle in a lane from the image captured by the camera; and a vehicle controller that performs control of returning the vehicle to the learned traveling line when a yaw rate due to disturbance is generated.

Other solving means are described as appropriate in the embodiments.

The present invention can achieve stable traveling in a drive assist technique.

### BRIEF DESCRIPTION OF THE DRAWINGS

FIG. 1 is a diagram showing a configuration of a travel control device according to an embodiment.

FIG. 2 is a diagram showing a specific example of a learning process in the embodiment.

FIG. 3 is a table showing satisfaction and non-satisfaction of learning conditions.

FIG. 4 is a diagram explaining an “OK condition”.

FIG. 5 is a diagram in which satisfaction and non-satisfaction of the learning conditions are shown as a timing chart.

FIG. 6 is a diagram showing control of a vehicle in the case where no learning of a traveling line is performed in no-learning ranges.

FIG. 7 is a diagram showing control of the vehicle in the case where the learning of the traveling line is performed in the entire range of the lane.

FIG. 8 is a diagram showing vehicle control.

FIG. 9 is a diagram showing a relationship between a yaw angle of the vehicle and a yaw rate control amount.

FIG. 10 is a diagram showing a relationship between a lateral position deviation with respect to the learned traveling line and a yaw rate control gain.

FIG. 11 is a diagram showing a procedure of a process performed by a learner in the embodiment.

FIG. 12 is a diagram showing a procedure of a process performed by a vehicle controller in the embodiment.

### DETAILED DESCRIPTION OF THE EMBODIMENTS

Next, a mode for carrying out the present invention (referred to as “embodiment”) is described in detail with reference to the drawings as appropriate. Note that, in the embodiment, a vehicle is assumed to be performing a lane keep assist process.

### (Travel Control Device 1)

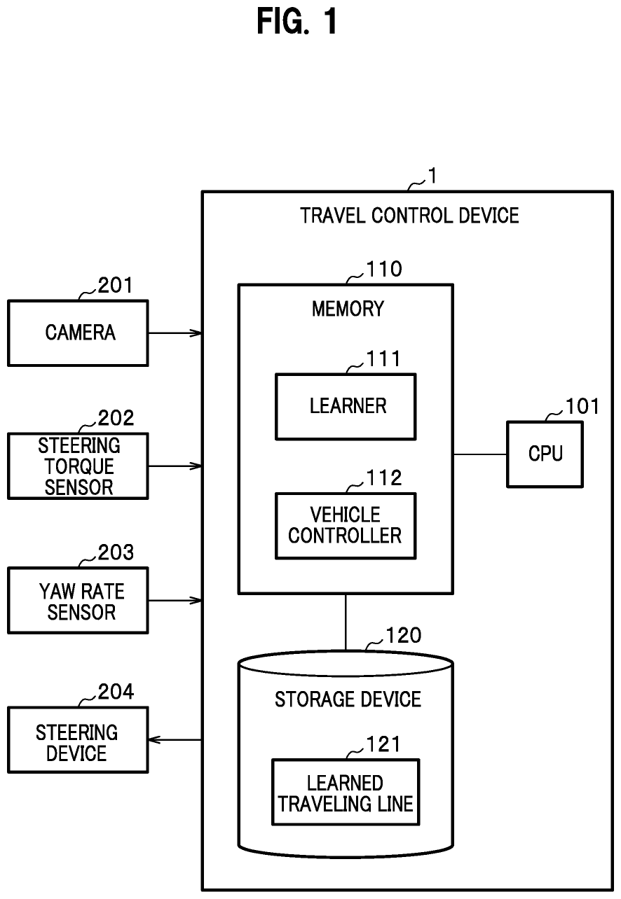

FIG. 1 is a diagram showing a configuration of a travel control device 1 according to the embodiment.

The travel control device 1 is a device mounted in an engine control unit (ECU). The travel control device 1 includes a central processing unit (CPU) 101, a memory 110, and a storage device 120. In this example, the memory 110 is formed of a read-only memory (ROM) and the like. Moreover, the storage device 120 is formed of a random access memory (RAM) and the like.

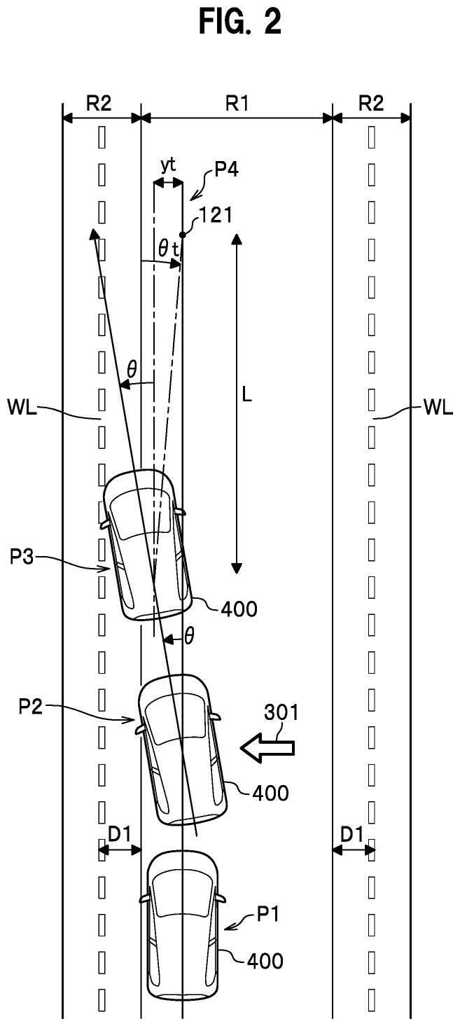

Moreover, the travel control device 1 obtains information from a camera 201, a steering torque sensor 202, a yaw rate sensor 203, and the like that are mounted in a vehicle 400 (see FIG. 2 and the like) and sends a steering command to a steering device 204.

The camera 201 captures at least a forward-view of the vehicle 400.

The steering torque sensor 202 detects torque applied to a not-shown steering wheel and outputs a steering torque signal indicating the detection result.

The yaw rate sensor 203 detects an angular velocity of the vehicle 400 about a vertical axis.

The steering device 204 includes a steering ECU, an electric motor, and the like that are not shown. The electric motor changes a direction of the steering wheel by, for example, applying force to a rack-and-pinion mechanism. The steering ECU drives the electric motor according to the steering command received from the travel control device 1 or information received from the steering wheel and causes the electric motor to change the direction of the steering wheel.

The CPU 101 executes a program stored in the memory 110 and a learner 111 and a vehicle controller 112 are thereby implemented.

The learner 111 recognizes a line (traveling line) in which the vehicle 400 is traveling based on a video or the like captured by the camera 201 and calculates a yaw angle. Moreover, the learner 111 determines whether a learning condition to be described later is satisfied based on information received from the yaw rate sensor 203 and the like. If the learning condition is satisfied, the learner 111 learns the traveling line in which the vehicle 400 is currently traveling and stores the learned traveling line in the storage device 120 as a learned traveling line 121. Processes performed by the learner 111 are described later.

Moreover, the vehicle controller 112 determines whether the traveling line in which the vehicle 400 is currently traveling has deviated from the learned traveling line 121 due to disturbance 301 (see FIG. 2) or the like. When the traveling line has deviated from the learned traveling line 121, the vehicle controller 112 sends the steering command to the steering device 204 to return the vehicle 400 to the learned traveling line 121. Presence or absence of the disturbance 301 is determined based on a signal received from the yaw rate sensor 203 and the like.

FIG. 2 is a diagram showing a specific example of a learning process in the embodiment.

A learning range R1 of the traveling line is set in advance. The learning range R1 is set inside white lines WL indicating both ends of a lane. Moreover, no-learning ranges R2 are set in ranges other than the learning range R1. The learning range R1 and the no-learning ranges R2 are described later.

The learning range R1 is set in a region away from each of the white lines WL, located on both sides of the vehicle 400 (host vehicle), by a predetermined distance D 1. Specifically, the learning range R1 is set between both white lines WL. Note that the used learning process may be any process in which the position of the host vehicle (position with respect to the white lines WL) is learned based on the video captured by the camera 201.

The learner 111 learns the current traveling line when the vehicle 400 is traveling in the learning range R1 and the driver is not operating the steering wheel. In this case, the learner 111 learns the traveling line of the vehicle 400 (host vehicle) with respect to the positions of both white lines WL, based on an image captured by the camera 201. The learned traveling line is referred to as the learned traveling line 121. The learned traveling line 121 can be located anywhere within the learning range R1. Specifically, the traveling line may be learned at the center of the learning range R1 or in an end portion of the learning range R1. Note that the traveling line and the learned traveling line 121 are straight lines extending in a traveling direction of the vehicle 400.

Then, when the traveling line of the vehicle 400 moves from the learned traveling line 121 due to the disturbance 301 caused by wind or the like, the vehicle controller 112 performs control of returning the vehicle 400 to the learned traveling line 121. In this case, the vehicle controller 112 determines whether the steering operation (steering) by the driver is performed. The vehicle controller 112 determines whether the steering operation by the driver is present or absent based on a signal sent from the steering torque sensor 202. Then, when no steering is performed, the vehicle controller 112 performs control of returning the vehicle 400 to the learned traveling line 121.

Specifically, the learner 111 learns the traveling line at a position P1 and sets the learned traveling line 121. Then, assume that the vehicle 400 receives the disturbance 301 such as crosswind in a leftward direction in the drawing at a position P2. As a result of this disturbance 301, the vehicle 400 tilts toward the left side in the drawing at a yaw angle θ. As a result, a horizontal position deviation of yt from the learned traveling line 121 is generated at a position P3.

Thus, the vehicle controller 112 generates a yaw rate (steering force) in a direction of θ+θt to return the vehicle 400 to the learned traveling line 121 at a position P4 that is a distance L away from the position P3.

Note that the vehicle controller 112 determines whether the disturbance 301 has occurred based on the detection of the yaw rate by the yaw rate sensor 203 and the video captured by the camera 201.

Performing such control allows the vehicle 400 to be quickly returned to the original traveling line (learned traveling line 121) when the vehicle 400 receives unexpected disturbance 301 while traveling along a predetermined traveling line. The embodiment can thus improve the feeling of the driver.

Moreover, there is a case where the driver causes the vehicle 400 (host vehicle) to travel while intentionally avoiding an obstacle (motorcycle, bicycle, pedestrian, fallen objects, and the like) varying in speed with the vehicle 400. When a location where the vehicle 400 travels to avoid the obstacle is within the learning range R1, the traveling line along which the vehicle 400 travels to avoid the obstacle is learned as a new learned traveling line 121. Since the traveling line along which the vehicle 400 travels to avoid the obstacle is not recognized as an irregular traveling line as described above, the vehicle 400 does not return to the traveling line before the avoidance of the obstacle. The embodiment can thus reduce the case where the traveling line intended by the driver is disturbed.

Moreover, the no-learning ranges R2 are set outside the learning range R1 as described above. Specifically, regions near the end portions of the lane are set as the no-learning ranges R2.

Furthermore, the learner 111 does not learn the traveling line when the vehicle 400 is traveling in the no-learning ranges R2. The no-learning ranges R2 are described later.

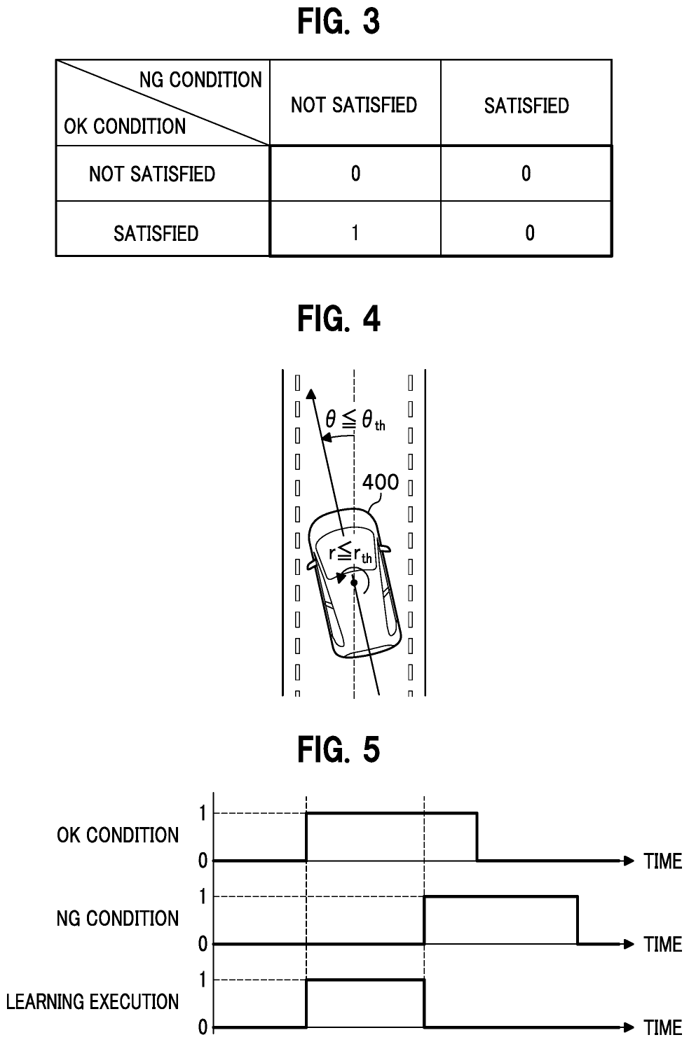

FIGS. 3 to 5 are diagrams showing learning conditions used by the learner 111. The determination in FIGS. 3 to 5 is performed when the vehicle 400 is traveling in the learning range R1. FIG. 1 is also referred to as appropriate.

FIG. 3 is a table showing satisfaction and non-satisfaction of the learning conditions.

In FIG. 3, an “OK condition” indicates that the vehicle 400 is traveling along a straight road. Checking of the OK condition is performed by causing the learner 111 to monitor the yaw angle that is the tilt of the traveling line with respect to the lane, the yaw rate of the vehicle 400, and the like. The learner 111 calculates the yaw angle with respect to the lane based on the video captured by the camera 201. For example, the learner 111 detects a line parallel to the white lines WL (see FIG. 2) in the video captured by the camera 201 and calculates the deviation angle between the detected line and the vehicle 400 to calculate the yaw angle.

The learner 111 performs determination relating to the yaw rate based on the signal sent from the yaw rate sensor 203. Specifically, the “OK condition” is satisfied when the yaw angle θ is equal to or smaller than a predetermined angle θth and the yaw rate r of the vehicle 400 is equal to or smaller than a predetermined value rth as shown in FIG. 4.

Moreover, an “NG condition” refers to the case where steering by the driver is performed. The learner 111 performs determination of the “NG condition” by detecting the steering torque, the steering angle, the steering speed, and the like. The learner 111 calculates the steering torque, the steering angle, and the steering speed based on signals sent from the steering torque sensor 202. Specifically, the learner 111 monitors at least one of the steering torque, the steering angle, and the steering speed. Then, when at least one of the steering torque, the steering angle, and the steering speed is present, the learner 111 determines that the “NG condition” is satisfied. Note that the learner 111 determines that the “NG condition” is satisfied also when the control direction of the vehicle 400 by the vehicle controller 112 is opposite to the steering torque. For example, when the vehicle 400 enters a cant and drifts due to the cant, the vehicle controller 112 performs control of resisting the cant by attempting to return the vehicle 400 to the learned traveling line 121. In the embodiment, when the steering torque and the control direction of the vehicle 400 by the vehicle controller 112 become opposite to each other in such a case, the “NG condition” is satisfied. In other words, no learning is performed. Specifically, when the control by the vehicle controller 112 is opposite to the steering intention of the driver, the learning is immediately stopped. Accordingly, the control by the vehicle controller 112 becomes absent and it is possible to reduce strangeness felt by the driver such as heavy steering wheel.

Moreover, when the steering torque and the control direction of the vehicle 400 by the vehicle controller 112 are the same direction, the learner 111 may determine that the “NG condition” is not satisfied. When the vehicle 400 enters a cant and drifts due to the cant as described above, the vehicle controller 112 attempts to return the vehicle 400 to the learned traveling line 121. In this case, if the driver operates the steering wheel and the “NG condition” is thereby immediately satisfied, that is the learning is stopped, the control by the vehicle controller 112 stops. The driver thus returns the vehicle to the lane center portion by himself/herself and the feeling degrades. The learning can be made to continue by determining that the “NG condition” is not satisfied (provided that the “OK condition” is satisfied) when the steering torque and the control direction of the vehicle 400 by the vehicle controller 112 are the same direction. As a result, the driver can continuously receive assistance by the vehicle controller 112.

In the table shown in FIG. 3, “1” indicates that the learning is executed and “0” indicates that the learning is not executed. As illustrated in FIG. 3, the learning executed only when the “OK condition” is satisfied and the “NG condition” is not satisfied. Specifically, the learning is executed only when the vehicle 400 is traveling along a straight road and the steering by the driver is not performed. When the steering by the driver is performed, the learned traveling line 121 is reset (deleted). Moreover, as described later, when at least one of the satisfaction of the “NG condition” and the non-satisfaction of the “OK condition” is established while the learning is performed, the learner 111 stops the learning and resets (deletes) the learned traveling line 121.

FIG. 5 is a diagram in which the table shown in FIG. 3 is converted to a timing chart. In the timing chart of FIG. 5, lines indicate the “OK condition”, the “NG condition”, and “presence or absence of execution of learning”, respectively, from the top. In the timing chart of FIG. 5, “0” indicates that the condition is not satisfied and “1” indicates that the condition is satisfied. As shown in FIG. 5, when the “NG condition (steering by the driver)” is satisfied (“1”), the learning is not executed (“execution of learning: 0”) even in the state where the “OK condition” is satisfied (“1”). The same applies to the opposite.

As described above, when the steering by the driver is performed, the driver is in the middle of changing of the traveling line and the learning is thus not executed. In other words, when the driver is steering the vehicle 400, the learner 111 does not learn the traveling line. Accordingly, the control by the vehicle controller 112 is also not executed. The driver thus does not feel the steering reaction force felt by the driver in the vehicle control. Accordingly, it is possible to reduce strangeness of the steering reaction force felt by the driver.

The learning is performed when the vehicle 400 is traveling along a straight road (“OK condition” is satisfied”). In reverse, the learning is not performed when the lane in which the vehicle 400 is traveling is not a straight road. This can avoid the case where the vehicle 400 travels while maintaining a traveling line deviating from the direction along the road, and reduce the strangeness felt by the driver.

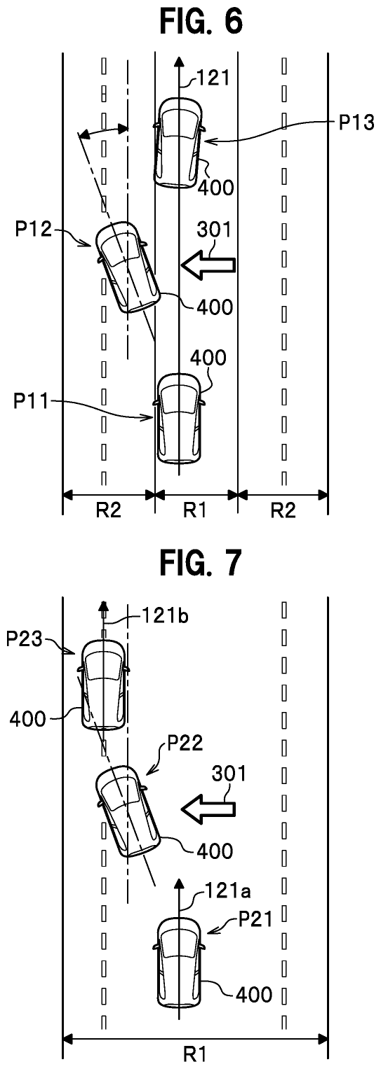

FIG. 6 is a diagram showing control of the vehicle 400 in the case where no learning of the traveling line is performed in the no-learning ranges R2. Moreover, FIG. 7 is a diagram showing control of the vehicle 400 in the case where the learning of the traveling line is performed in the entire range of the lane.

As shown in FIG. 6, first, the vehicle 400 traveling along the learned traveling line 121 (position P11) moves to the outside of the learning range R1 due to the disturbance 301 or the like (position P12). In such a case, the vehicle controller 112 returns the vehicle 400 to the learned traveling line 121 learned at the position P11 (position P13) if the steering by the driver is not performed. Specifically, since no learning is performed in the no-learning ranges R2, the vehicle 400 having moved to any of the no-learning ranges R2 (regions near the end portions of the lane) due to the disturbance 301 or the like is quickly returned to the learned traveling line 121 in the learning range R1. In other words, the vehicle 400 is returned from the region near the end portion of the lane to a region near the center.

Description is given of the case where the learning is performed in the entire range of the lane, that is the entire range of the lane is the learning range R1, with reference to FIG. 7. First, the learner 111 learns a learned traveling line 121a at a position P21 as in FIG. 6. Then, the vehicle 400 travels in one of the regions near the end portions of the lane due to the disturbance 301 such as crosswind (position P22). In this case, since the entire range of the lane is the learning range R1, the learner 111 learns the traveling line in a region to which the vehicle 400 has moved, if no steering is performed. Specifically, the learner 111 learns a learned traveling line 121b in the region near the end portion of the lane that is the region to which the vehicle 400 has moved. Accordingly, the vehicle 400 keeps traveling in the region near the end portion of the lane.

Setting the regions near the end portions of the lane as the no-learning ranges R2 as in FIG. 6 can avoid the case where the vehicle 400 learns a traveling line in the region near the end portion of the lane as the learned traveling line 121. As a result, the vehicle 400 does not keep traveling in the end portion of the lane.

As described above, in the embodiment, the learner 111 sets the regions near the end portions of the lane as the no-learning ranges R2 and does not learn the traveling position in the no-learning ranges R2. This can prevent the case where the vehicle 400 keeps traveling in the regions near the end portions of the lane when the vehicle 400 travels in the regions near the end portions of the lane due to unexpected disturbance 301.

Moreover, when the learned traveling line 121 is located near an end portion of the learning range R1, the vehicle 400 easily moves to a corresponding one of the no-learning ranges R2 due to the disturbance 301. In such a case, the vehicle controller 112 of the embodiment can quickly move the vehicle 400 to the learned traveling line 121.

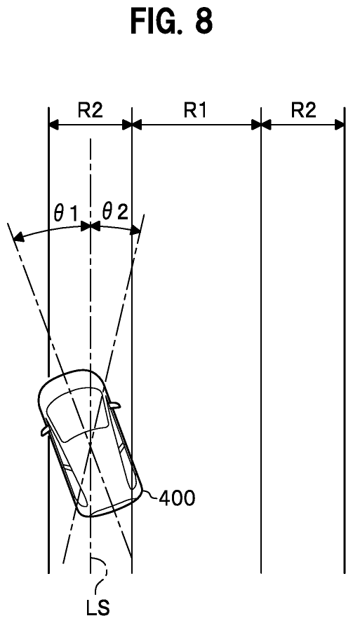

FIG. 8 is a diagram showing control of the vehicle 400 in the case where the driver intentionally moves the vehicle 400 to the outside of the learning range R1 (to the no-learning range R2) by steering the steering wheel and then no steering by the driver is performed.

First, as described above, assume that the driver intentionally steers the steering wheel (not shown) and the vehicle 400 moves to the outside of the learning range R1 (no-learning range R2). Then, assume that the driver stops steering the steering wheel at a point where the vehicle 400 moves to the outside of the learning range R1 (no-learning range R2).

As described above, when the driver steers the steering wheel, the learned traveling line 121 that has been used so far (see FIG. 2) is reset (deleted). Specifically, when the driver steers the steering wheel and the vehicle 400 moves to the outside of the learning range R1 (no-learning range R2), the learned traveling line 121 learned in the learning range R1 is reset. In addition, since the vehicle 400 is traveling in the no-learning range R2, the learner 111 does not learn a new learned traveling line 121. Accordingly, even if the vehicle controller 112 attempts to return the vehicle 400 to the learned traveling line 121, there is no learned traveling line 121 to be the target. In such a case, the vehicle controller 112 performs control of returning the vehicle 400 to the end portion of the learning range R1.

Specifically, the vehicle controller 112 generates a yaw rate in a direction of θ (=θ1+θ2) obtained by adding up a current yaw angle deviation θ1 in the vehicle 400 and a deviation angle θ2 for reaching the end portion of the learning range R1 as shown in FIG. 8. In this case, the yaw angle θ1 and the deviation angle θ2 are, for example, angles with respect to a line (one-dot chain line LS) that passes the center of the vehicle 400 and that is parallel to the white lines WL (see FIG. 2). In other words, the vehicle controller 112 calculates the yaw angle θ1 and the deviation angle θ2 based on the white lines WL (see FIG. 2) or the like in the video captured by the camera 201. Note that the deviation angle θ2 is calculated from the lateral position of the vehicle 400 and the like.

The control shown in FIG. 7 is performed when the driver does not steer the steering wheel in the no-learning range R2.

As described above, there is a case where the vehicle 400 moves to the no-learning range R2 by the steering of the driver and the driver stops the steering at the point where the vehicle 400 moves to the no-learning range R2. The process shown in FIG. 8 can cause the vehicle 400 to quickly move to the learning range R1 even in such a case.

Moreover, there is a case where the vehicle 400 moves to the no-learning range R2 by the steering of the driver and then the vehicle 400 further receives the disturbance 301 toward the end portion of the lane (for example, toward the left side in the drawing of FIG. 8). However, in the process shown in FIG. 8, the vehicle controller 112 immediately moves the vehicle 400 toward the learning range R1 (that is, the region near the center portion of the lane) also when such disturbance 301 occurs. This can prevent the vehicle 400 from reaching the end portion of the lane (region near the white line WL) due to the disturbance 301 occurring after the movement of the vehicle 400 to the no-learning range R2.

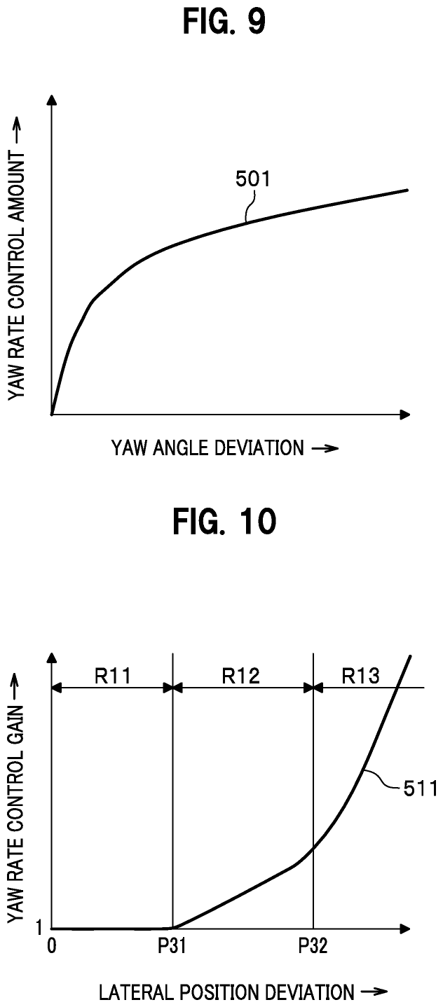

FIG. 9 is a diagram showing a relationship between the yaw angle of the vehicle 400 and a yaw rate control amount. The yaw rate control amount is an amount of a yaw rate generated by the vehicle controller 112 in the vehicle 400 when the vehicle 400 returns to the learned traveling line 121.

Note that FIG. 9 is a process performed when the learned traveling line 121 is learned.

In this case, the yaw angle is a deviation of the yaw angle in the vehicle 400 with respect to the learned traveling line 121. The deviation of the yaw angle is the yaw angle deviation θ1 with respect to the one-dot chain line LS being the line that passes the center of the vehicle 400 and that is parallel to the white lines WL (see FIG. 2) in FIG. 8.

The vehicle controller 112 performs control such that the larger the deviation of the yaw angle is, the larger the yaw rate control amount is as in a yaw rate control amount curve 501 shown in FIG. 9.

To put it the other way around, the vehicle controller 112 performs control such that the smaller the deviation of the yaw angle is, the smaller the yaw rate control amount is. When a large yaw rate is generated in the case where the deviation of the yaw angle is small, the yaw angle of the vehicle 400 overshoots “0”. Then, the vehicle controller 112 generates a yaw rate again to set back the overshooting yaw angle. This is repeated and the vehicle 400 thereby sways in the yaw angle direction. Causing the vehicle controller 112 to perform control such that the smaller the deviation of the yaw angle is, the smaller the yaw rate control amount is as shown in FIG. 9 can suppress swaying of the vehicle 400 in the yaw angle direction. Specifically, performing the yaw rate control as shown in FIG. 9 enables assistance of straight traveling and can improve the straight running performance of the vehicle 400. Note that the yaw rate control is control of the yaw rate performed when the vehicle 400 is returned to the learned traveling line 121.

Although the yaw rate control amount logarithmically increases with respect to the yaw angle in FIG. 9, for example, the yaw rate control amount may proportionally increase with respect to the yaw angle.

FIG. 10 is a diagram showing a relationship between a lateral position deviation with respect to the learned traveling line 121 and a yaw rate control gain. The yaw rate control gain is a gain by which the yaw rate control amount to be generated in the vehicle 400 is multiplied. As shown in FIG. 10, the yaw rate control gain has a value of “1” or more.

Moreover, the lateral position deviation is a deviation of the lateral position of the vehicle 400 in the case where the lateral position of the learned traveling line 121 is set as 0. Note that the lateral position is the position of an x coordinate in the case where a lane width direction is set as an x-axis.

As shown in FIG. 10, when the lateral position deviation is within a range R11, the vehicle controller 112 sets the yaw rate control gain to “1”. In this case, the range R11 is a range in which the lateral position deviation is from the learned traveling line 121 (lateral position deviation “0”) to the end portion of the learning range R1 (lateral position deviation “P31”). The yaw rate control gain is changed depending on the lateral position deviation, according to a yaw rate control gain curve 511 shown in FIG. 10.

In the case where the lateral position deviation is larger than the end portion of the learning range R1 (lateral position deviation “P31”) (ranges R12 and R13), the vehicle controller 112 sets the yaw rate control gain such that the larger the lateral position deviation is, the larger the yaw rate control gain is. Specifically, the farther away the vehicle 400 is from the learning range R1, the larger the yaw rate control gain is.

This allows the vehicle 400 to quickly return to the learned traveling line 121. Specifically, when the lateral position deviation is large, the yaw rate control gain is also large. Accordingly, the vehicle 400 can quickly return to the learning range R1 even when the disturbance 301 is large and stable traveling in the learning range R1 can be achieved. Performing such a process enables stable traveling in the learning range R1 (near the center portion of the lane) even when large disturbance 301 (see FIG. 2) occurs.

Description is given of the case where the yaw rate control amount is multiplied by a large yaw rate control gain to return the vehicle 400 to the learned traveling line 121 when the vehicle 400 moves away from the learned traveling line 121, even if slightly. In such a case, a large yaw rate control amount is generated even if the lateral deviation with respect to the learned traveling line 121 is small. When such a situation occurs, the vehicle 400 may overshoot the position of the learned traveling line 121. In such a situation, the vehicle controller 112 generates a yaw rate again to set back the excessive lateral deviation. Repeating this operation causes the vehicle 400 to sway in the yaw angle direction. The feeling may be thus degraded. Accordingly, in the embodiment, when the vehicle 400 moves to the outside of the learning range R1, the yaw rate control gain is generated as shown in FIG. 10. This can prevent the vehicle 400 from swaying in the yaw angle direction.

In the example shown in FIG. 10, an increase rate of the yaw rate control gain in the range R13 is higher than an increase rate of the yaw rate control gain in the range R12. In this case, the range R12 is a range of end portion of the learning range R1 (lateral deviation position “P31”)≤lateral position deviation≤region near the end portion of the lane (lateral deviation position “P32”). Meanwhile, the range R13 is a range of region in the lane near the end portion of the lane (lateral deviation position “P32”)<lateral position deviation.

This configuration can achieve such control that the closer the vehicle 400 is to the region near the end portion of the lane, the more quickly the vehicle 400 is returned to the learning range R1.

Note that the increase rate of the yaw rate control gain in the range R13 does not have to be set higher than the increase rate of the yaw rate control gain in the range R12.

### <Flowchart>

### (Learner 111)

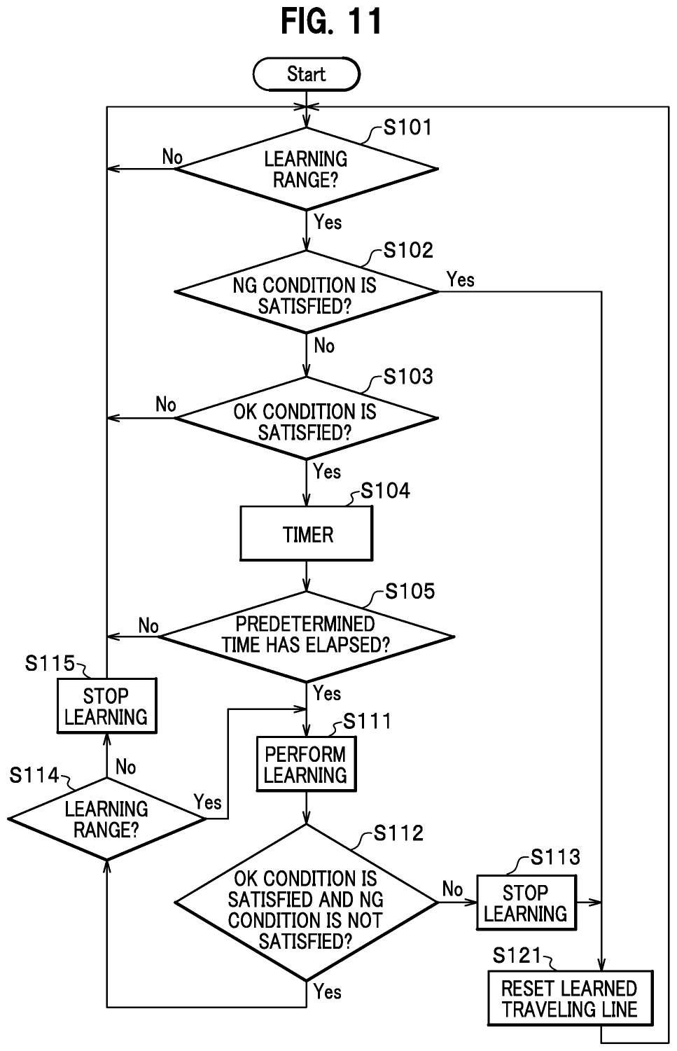

FIG. 11 is a diagram showing a procedure of a process performed by the learner 111 in the embodiment.

First, the learner 111 determines whether the vehicle 400 is traveling in the learning range R1 (S101).

When the vehicle 400 is not traveling in the learning range R1 (No in S101), the learner 111 causes the process to return to step S101.

When the vehicle 400 is traveling in the learning range R1 (Yes in S101), the learner 111 determines whether the “NG condition” shown in FIG. 3 is satisfied (S102).

When the “NG condition” is not satisfied (No in S102), the learner 111 determines whether the “OK condition” shown in FIG. 3 is satisfied (S103).

When the “OK condition” is not satisfied (No in S103), the learner 111 causes the process to return to step S101.

When the “OK condition” is satisfied (Yes in S103), the learner 111 performs counting of a timer (not shown) (timer: S104).

Then, the learner 111 determines whether the count of the timer is equal to or more than predetermined time (predetermined time has elapsed) (S105).

When the count is less than the predetermined time (predetermined time has not elapsed) (No in S105), the learner 111 causes the process to return to step S101.

When the count is equal to or more than the predetermined time (predetermined time has elapsed) (Yes in S105), the learner 111 learns the current traveling position (S111). The learner 111 stores the learned traveling line as the learned traveling line 121 in the storage device 120. Then, the learner 111 causes the process to return to step S101. In this case, the learner 111 updates the learned traveling line 121 stored in the storage device 120 with the learned traveling line 121 that is newly learned. Note that the count of the timer is reset when the learning is started.

Then, the learner 111 determines whether the aforementioned “OK condition” is satisfied and the “NG condition” is not satisfied (S112).

When at least one of the non-satisfaction of the “OK condition” and the satisfaction of the “NG condition” is established (No in S112), the learner 111 stops the learning (S113) and performs a process of S121. The process of S121 is described later.

When the “OK condition” is satisfied and the “NG condition” is not satisfied (Yes in S112), the learner 111 determines whether the vehicle 400 is traveling in the learning range R1 (S114).

When the vehicle 400 is traveling in the learning range R1 (Yes in S114), the learner 111 causes the process to return to step S111 and continues the learning.

When the vehicle 400 is not traveling in the learning range R1 (No in S114), the learner 111 stops the learning (S115) and causes the process to return to step S101. Note that, in step S115, the learner 111 stops the learning but does not reset the learned traveling line 121. Specifically, the learned traveling line 121 is in a state stored in the storage device. Moreover, the case where the vehicle 400 is not traveling in the learning range R1 in step S114 can be assumed to be cases such as the case where the vehicle 400 has moved to the outside of the learning range R1 due to disturbance or the like.

When the “NG condition” is not satisfied in step S102 (Yes in S102), the learner 111 resets (deletes) the learned traveling line 121 (S121). Then, the learner 111 causes the process to return to step S101.

### (Vehicle Controller 112)

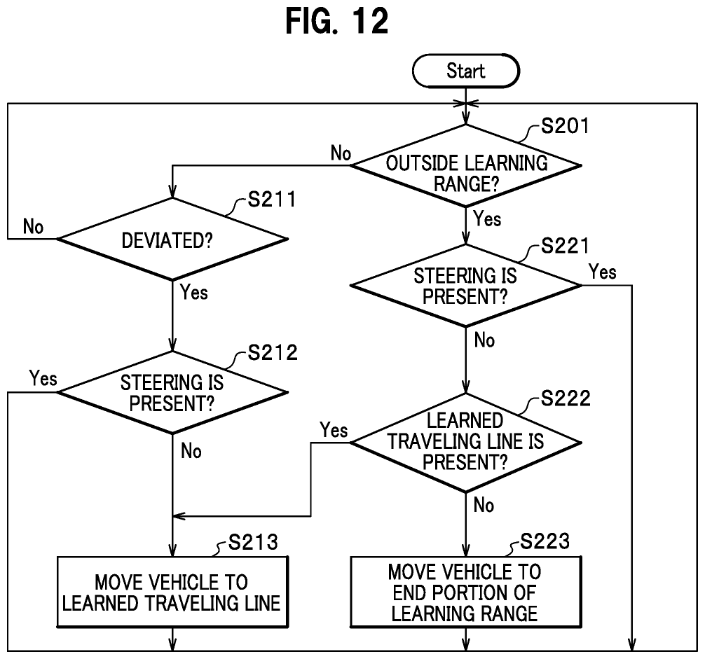

FIG. 12 is a diagram showing a procedure of a process performed by the vehicle controller 112 in the embodiment.

Note that the process in FIG. 11 and the process in FIG. 12 are performed in parallel.

The vehicle controller 112 determines whether the vehicle 400 is traveling outside the learning range R1 (outside of the learning range; that is the no-learning ranges R2) (S201).

When the vehicle 400 is traveling inside the learning range R1 (No in S201), the vehicle controller 112 determines whether the current traveling line is deviated from the learned traveling line 121 (S211).

When the current traveling line is not deviated from the learned traveling line 121 (No in S211), the vehicle controller 112 causes the process to return to step S201.

When the current traveling line is deviated from the learned traveling line 121 (Yes in S211), the vehicle controller 112 determines whether steering of the steering wheel (not shown) by the driver is present (S212).

When the steering of the steering wheel is absent (No in S212), the vehicle controller 112 performs the control shown in FIG. 2 to move the vehicle 400 to the learned traveling line 121 (S213). Then, the vehicle controller 112 causes the process to return to step S201.

When the steering of the steering wheel is present (Yes in S212), the vehicle controller 112 causes the process to return to step S201. Note that, in this case, the learner 111 resets the learned traveling line 121 as described above.

Moreover, when the vehicle 400 is traveling outside the learning range R1 (outside of the learning range) in step S201 (Yes in step S201), the vehicle controller 112 determines whether the steering of the steering wheel by the driver is present (S221).

When the steering of the steering wheel is present (Yes in S221), the vehicle controller 112 causes the process to return to step S201. Note that, in this case, the learner 111 resets the learned traveling line 121 as described above.

When the steering of the steering wheel is absent (No in S221), the vehicle controller 112 determines whether the learned traveling line 121 is stored (present) in the storage device 120 (S222).

When the learned traveling line 121 is stored (present) in the storage device 120 (Yes in S222), the vehicle controller 112 executes step S213.

When the learned traveling line 121 is not stored in the storage device 120 (No in S222), the vehicle controller 112 performs the control shown in FIG. 8 to move the vehicle 400 to the end portion of the learning range R1 (S223). Then, the vehicle controller 112 causes the process to return to step S201.

What is claimed is:

1. A vehicle control device comprising:
a camera that is mounted in a vehicle and that captures a forward-view image of the vehicle;
a learner that learns a traveling line of the host vehicle in a lane from the image captured by the camera; and
a vehicle controller that performs control of returning the vehicle to the learned traveling line when a yaw rate due to disturbance is generated.

2. The vehicle control device according to claim 1, wherein
in the lane, a range that has a predetermined width from a center of a traveling width is set as a learning range and a range other than the learning range is set as a no-learning range, and
the learner does not learn the traveling line in the no-learning range.

3. The vehicle control device according to claim 2, wherein,
in a state where
the traveling line is not learned, and
the vehicle is traveling in the no-learning range and a driver is not steering a steering wheel,
the vehicle controller performs control of returning the vehicle to an end portion of the learning range.

4. The vehicle control device according to claim 1, wherein the learner learns the traveling line on condition that the driver is not performing steering.

5. The vehicle control device according to claim 1, wherein when the vehicle is returned to the learned traveling line, a gain of steering force caused by control of a yaw angle in the vehicle is set depending on an angle formed by a traveling direction of the vehicle with respect to the traveling line.

6. The vehicle control device according to claim 1, wherein when the vehicle is returned to the learned traveling line, a gain of steering force caused by lateral deviation control of the vehicle in the vehicle is changed depending on a deviation between a lane and a lateral position of the vehicle.

7. A vehicle in which the vehicle control device according to claim 1 is mounted.
